(19) United States
(12) Patent Application Publication
(10) Pub. No.: US 2002/0116862 A1
(43) Pub. Date: Aug. 29, 2002

(54) Method and apparatus for attracting marine crustaceans to a desired location

(76) Inventor: Robert McNeil, Dominion (CA)

Correspondence Address: Jon C. Gealow & Associates, 2903 N. Bayview Lane, McHenry, IL, 60050-9629, US

(21) Appl. No.: 10/008,640

(22) Filed: Nov. 8, 2001

(30) Foreign Application Priority Data
Nov. 8, 2000 (CA) 2,325,291

(51) Int. Cl. A01K 69/00

(52) U.S. Cl. 43/100

(57) ABSTRACT

Method and apparatus for emitting pre-recorded sounds that simulate the natural sounds present in the preferred habitat of lobster and other marine crustaceans. The attractant sound simulates the sound of water splashing, gurgling and moving as waves, current or tidal shift impact on the reef, boulder or other such geographic feature on the ocean floor. To lobsters and other crustaceans, these sounds represent shelter from prey and the presence of food source. When the apparatus is placed in a trap and the attractant sound is emitted, lobsters and other crustaceans are attracted to the source of the sound and enter the trap.

### FIELD OF THE INVENTION

The present invention relates to a method and apparatus for attracting marine crustaceans to a desired location. In particular, the invention relates to a method and apparatus for attracting crustaceans to a desired location by emitting certain sound waves from that location.

### BACKGROUND OF THE INVENTION

Lobsters and other marine crustaceans prefer as their habitat areas which provide crevasses, orifices and other such geographical features. These features enable the lobsters to hide from their predators yet still access their food supply. Such habitats include ocean reefs, cobble bottoms, and areas with rocks or boulders. There is a background noise of splashing, gurgling and moving water inherent to these preferred habitats. The noise results from the impact of water in the form of waves, current or tidal shift on the reef, boulder or other such geographic feature.

In most jurisdictions, lobster harvesters operate under licence granted by the government authority responsible for fisheries. Those licences generally permit the harvester to set a prescribed number of traps during a specified lobster fishing season. The harvester's decision where to locate the traps is based predominantly on trial and error. Lobster are trapped in either rectangular wire traps, or in the more traditional quonset style wooden traps. Lobster traps have two chambers: a parlour and a bait chamber. Bait, preferably mackerel, herring or other fish with a relatively high oil content, is placed in the bait chamber. The lobster, attracted by the odour of the bait, enters the parlour through a ring opening and then proceeds through an angled net (referred to in the lobster fishing art as the “heading”), to the bait room. In the bait room, escape hatches exist to allow small lobsters to exit the trap. Lobsters of a size large enough to harvest cannot exit the bait room. The bait room also has a hatch through which the harvester removes the lobster. During lobster fishing season, the harvester generally checks the traps on a daily basis to remove any lobster caught and to re-bait the trap.

Although there is a strong desire amongst lobster harvesters to increase yield, minimal changes have been adopted in the industry over the past couple of centuries to accomplish this objective. One such change has been the move to larger traps. Traditionally, traps were three feet long (referred to in the art as “three bow”), however, in recent years, harvesters have moved to traps that are four feet long (referred to as “four bow”). In theory, the increased capacity of the larger traps enables the harvester to increase yield. The change from wooden traps to wire traps was also motivated, in part, by a desire to increase yield. It was thought that wire traps are less visible to the lobsters with the result that the lobsters are more likely to enter them. These changes have not resulted in a substantial increase in yield for lobster harvesters.

### SUMMARY OF THE INVENTION

The apparatus of the present invention emits sounds which simulate the natural sounds present in the preferred habitat of lobster and other marine crustaceans. In particular, the sounds emitted simulate the sound of water splashing, gurgling and moving as waves, current or tidal shift impact on the reef, boulder or other such geographic feature on the ocean floor. To lobsters and other crustaceans, these sounds represent shelter from prey and the presence of food source. When the apparatus is placed in a trap and it emits the simulated sound, lobsters and other crustaceans are attracted to the source of the sound and enter the trap. As a result, the use of the apparatus significantly increases the number of lobster and other crustaceans caught over a certain period of time which, in turn, increases the productivity and profitability of the lobster harvester.

### BRIEF DESCRIPTION OF THE DRAWINGS

FIG. 1 is a schematic illustration of the apparatus of the present invention, the container being shown with the lid on.

FIG. 2 is a schematic illustration of the apparatus of the present invention, the container being shown with the lid removed from the container body.

FIG. 3 is a schematic illustration of an alternative embodiment of the present invention, shown in an exploded view.

FIG. 4 is a schematic diagram of the electrical circuitry of the apparatus of the present invention.

FIG. 5 illustrates the apparatus of the present invention placed in a lobster trap.

### DETAILED DESCRIPTION OF THE PREFERRED EMBODIMENT

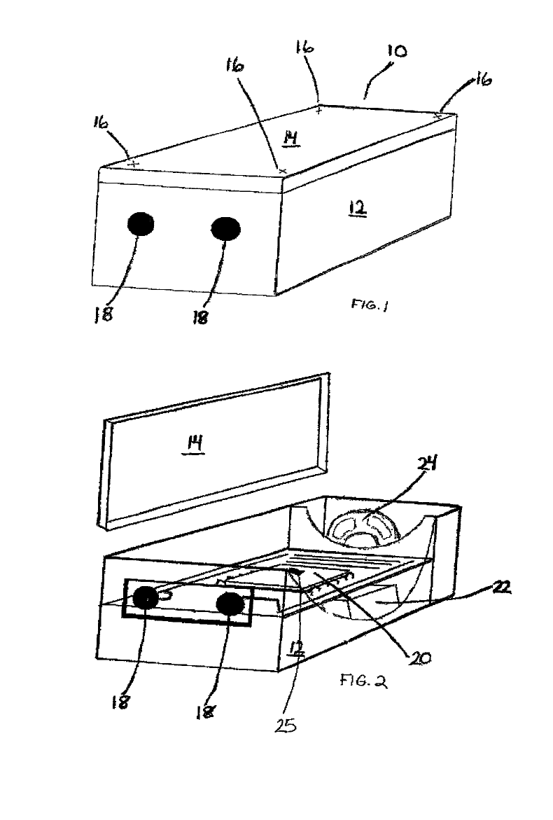

As shown in FIG. 1, the apparatus of the present invention is comprised of container 10 having container body 12 and lid 14.

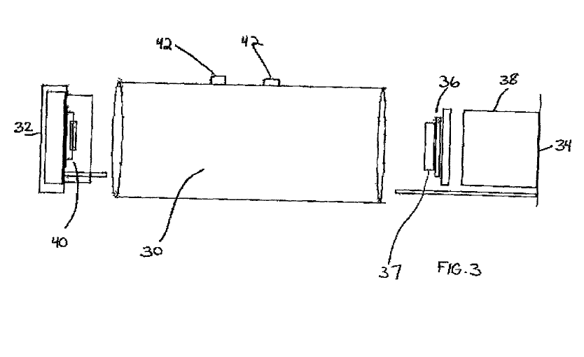

Container 10 is manufactured from water-proof, high impact plastic to enhance its durability and to minimize the weight of the apparatus. Container 10 may be parallelepiped-shaped as illustrated in FIGS. 1 and 2 or any other suitable shape. Container 10 is sized to be sufficiently small to conveniently fit through the hatch of the lobster trap and sufficiently large to house the required components. Lid 14 is removably fastened to container body 12 by stainless steel screws 16 or other suitable fastening means such that lid 14 can be either opened or removed from container body 12. An “O” ring (not shown) may be used to form a water tight seal between lid 14 and container body 16. Alternatively, lid 14 may be heat sealed to container body 12. Stainless steel contact points 18 are disposed on the exterior surface of one side of container 10.

The contents of container 10 are shown in FIG. 2. They are housed in container body 12 and consist of integrated circuit board 20, microchip 25, power supply 22 and speaker 24.

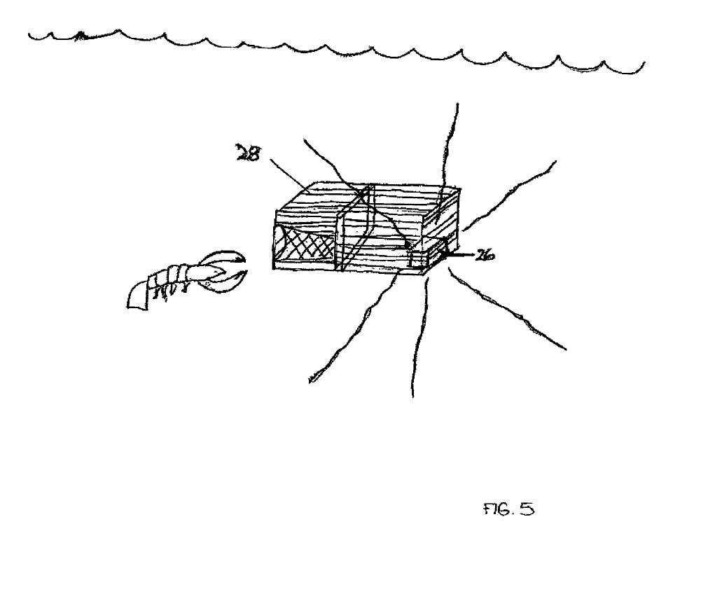

Integrated circuit board 20 is wired as illustrated in FIG. 4 or in any other suitable manner. Microchip 25 is connected to circuit board 20. An example of a suitable microchip is the ISD 2560 manufactured by Information Storage Devices. A sound which simulates the background sound present in a preferred habitat of a lobster is recorded onto the microchip. The recorded sound is the noise made by the movement of a liquid, for example, the sound of water splashing or gurgling. The sound can be generated artificially by a variety of means. For example, the sound can be generated by pumping water through a vent in a lobster containment area. Alternatively, the natural sound of the preferred habitat, or a naturally occurring sound identical or similar thereto, can be recorded. In a typical recording scenario, the sound is recorded on the microchip for a duration of 30 seconds and is then digitally looped to reproduce the sound on a continuous basis. The microchip has a temperature rating which exceeds the temperature range of the body of water into which the apparatus will be submerged.

Speaker 24 has dimensions which allow for it to readily fit in container 10. For example, a speaker with a diameter of 1¼ inches and ¼ of an inch deep is suitable. Speaker 24 has a mylar cone and supplies an 8 ohm load. Speaker 24 is wired to circuit board 20 in a suitable manner.

Power supply 22 must be sufficient to operate microchip 25. In a preferred embodiment, six D cell titanium batteries, each of 1.5 volts, is used. In the alternative, a 9 volt lithium battery may be used. Power supply 22 is wired to circuit board 20 in a manner well known to those in the art. Power supply 22 is sufficient to allow for normal operation of the unit over at least one fishing season. Optionally, an external switching means (not shown) may be installed on container 10 to permit completion of the electrical circuit which, in turn, allows operation of the apparatus in environments other than water. A heat wrap system, whereby a wire wrap is placed around the battery to keep it warm and operating at peak power in the event of extreme cold water, may be used to ensure that the power supply maintains fall power output in any temperature where the apparatus may be located. A regulator (not shown) is incorporated in the circuit to ensure that the microchip receives no more than 5 volts of power. In addition, a transistor and a resistor serve as a power management system to ensure when the unit is not in operation, no power is drawn from the power supply and when the unit is in operation, that it is operating at maximum efficiency.

Electrical contact points 18 are manufactured from stainless steel or other suitable corrosion resistant material. Contact points 18 extend through wall of container body 12 and are wired to power supply 22. In the alternative, an external switching means can be affixed to the exterior of container body 12 to manually activate the apparatus before it is submerged.

Once the aforementioned components have been installed in container body 12, container body 12 may optionally be filled with silicone prior to installing lid 14. The silicone serves to provide additional protection to the components from the salt water in which the apparatus is submerged in the event that there is a fault in the integrity of the seal between container body 12 and lid 14. The silicone also acts as a cushion to help absorb some of the shock and movement imposed by the water conditions on the ocean floor. The silicone further acts as a thermal insulator.

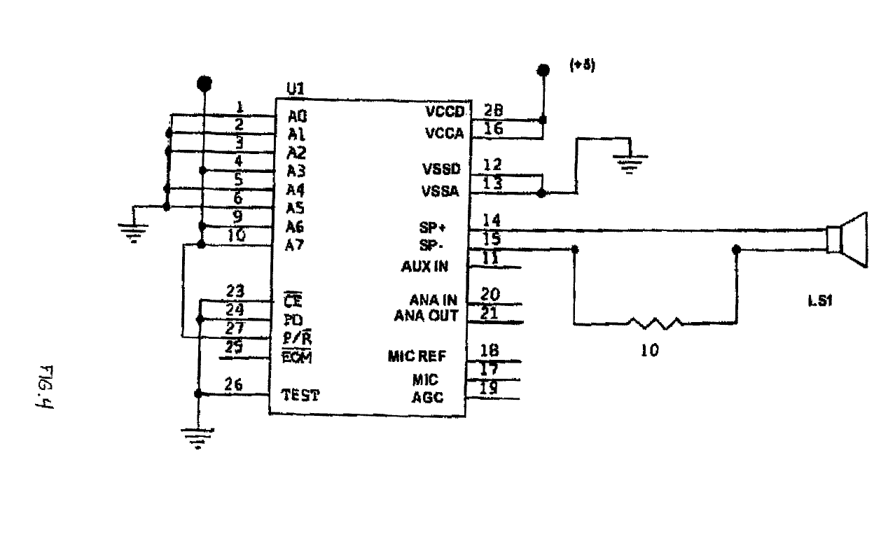

An alternative embodiment of the invention is illustrated in FIG. 3. Container body 30 is cylindrical and has end pieces 32, 34. It may be constructed from a section of polyvinyl chloride piping or any other suitable material. Container body 30 houses the same components as the parallelepiped shaped embodiment illustrated in FIGS. 1 and 2, namely, integrated circuit board 36, microchip 37, power supply 38 and speaker 40. Electrical contact points 42 are disposed on container body 30. End pieces 32, 34 are sealed to container body 30 in the same manner as lid 14 is sealed to container body 12.

The apparatus can be used with either the older style wooden traps or the newer style wire traps. The parallelepiped shaped embodiment is most suitable for the wire traps and the cylindrical shaped embodiment is most suitable for the quonset style traps. To operate the apparatus, the harvester inserts it into the bait room of the trap. The apparatus may be secured to the floor or the wall of the trap by means of a bracket, straps, screws, clips or any other suitable fastening means. In the alternative, the trap may be fitted with a wire cage to house the apparatus. In the further alternative, the apparatus may not be fixed to the trap in which case it would simply rest on the trap floor. The apparatus should be positioned such that the side of the container body emitting the attractant sound is not directed towards the ocean floor. The harvester then plunges the trap into the ocean. Once the apparatus is submerged, water activates contacts 18 which completes the circuit and activates apparatus. Upon activation, the attractant sound is emitted through speaker 24. The range of the apparatus is generally about 1 mile although this may vary depending on the ocean conditions. As illustrated in FIG. 5, lobsters within the vicinity of apparatus 28 sense the sound and, believing it to indicate that food and protection from their predators are available to them at the source of the sound, are attracted to and move towards apparatus 28. The apparatus may be used alone or together with traditional bait. The lobsters which have been attracted enter trap 26 which contains apparatus 28 or enter other traps in the vicinity of trap 26.

When the apparatus is in regular use, contact points 18 are cleaned on a periodic basis, for example once per week, to ensure completion of the circuit. To clean the contact points 18, the harvester simply rubs an abrasive scuff pad, which may be sold with the apparatus or separately, over the end of each contact point for several seconds. Contact points 18 can be routinely cleaned in this manner the traps are brought out of the water to be checked for harvest. As contacts points 18 are located on the exterior of container body 12, they can be accessed by the harvester without the having to remove the apparatus from the trap. Thus, minimal time is spent by the harvester to clean the contact points.

When a trap containing an apparatus is removed from the water, the circuit between contact points 18 is broken, and apparatus 28 deactivates. This deactivation advantageously conserves power supply 22 when apparatus 28 is not in use. Such deactivation occurs when the traps are removed from the water to check for lobster and to remove any lobsters which have been caught, or between seasons when the traps are not in use.

Once power supply 22 has been depleted, apparatus 28 is intended to be discarded. The harvester can readily determine whether power supply 22 is depleted by connecting contact points 18 with a piece of metal. If the attractant sound is emitted, the power supply is not yet depleted and the harvester can continue to use the apparatus. A suitable metallic tool can be provided with the apparatus for this purpose. Other conventional means of monitoring or testing power supply 22 can also be used.

Use of the apparatus of the present invention significantly increases the number of lobsters harvested in any particular time period. The result is an increase in yield. The unit may also be used to cause lobster to migrate from areas which are generally not harvested or to migrate into areas not generally populated by lobster. This provides the harvesters with an increased yield without unduly depleting the stock in the areas which are normally harvested. In order to cause such a migration to occur, a number of the apparatus may be used together at one location to increase the range of the sound emitted.

The apparatus is simple to use and requires little maintenance. Its use does not add substantially to the time expended by the harvesters in setting and checking their traps. The apparatus is sufficiently robust to withstand the rough water and adverse weather conditions to which lobster traps are often exposed. The apparatus also has no moving parts which reduces the likelihood of malfunction due to mechanical failure. Another advantage of the apparatus is that the use of traditional bait can be avoided.

Throughout the world, the physical conditions of lobster habitat vary widely and the parameters of the apparatus can be modified to adapt to these various conditions. In addition, the apparatus can be adapted for use as a baiting device of other marine crustaceans and marine animals.

The present invention has been shown and described with reference to preferred embodiments of the invention. It is to be understood that departures may be made therefrom within the spirit and scope of the invention.

The embodiments of the invention in which an exclusive Property or privilege is claimed are defend as follows:

1. An apparatus for attracting marine crustaceans to a desired location comprising:
(a) a storage means containing a recording of the background sound of a preferred habitat of said marine crustacean; and
(b) a means for transmitting said recording from said desired location.

2. The apparatus of claim 1 wherein said marine crustacean is a lobster.

3. The apparatus of claim 2 wherein said desired location is a lobster trap.

4. A method of attracting marine crustaceans to a desired location comprising emitting from said location a recording of the background sound of its preferred habitat.

5. The method of claim 4 wherein said marine crustacean is a lobster.

6. The method of claim 5 wherein said desired location is a lobster trap.
